(19) United States
(12) Patent Application Publication
(10) Pub. No.: US 2026/0279089 A1
(43) Pub. Date: Sep. 17, 2026

(54) INFORMATION PROCESSING SYSTEM AND IMAGE PROCESSING APPARATUS

(71) Applicant: Takao Okamura, Tokyo (JP)

(72) Inventor: Takao Okamura, Tokyo (JP)

(73) Assignee: Ricoh Company, Ltd., Tokyo (JP)

(21) Appl. No.: 19/423,285

(22) Filed: Dec. 17, 2025

(30) Foreign Application Priority Data
Mar. 13, 2025 (JP) 2025-039897

(51) Int. Cl. G06V 30/19; H04N 1/32

(52) U.S. Cl. CPC G06V 30/19007; H04N 1/32122

(57) ABSTRACT

An information processing system includes a memory and circuitry. The memory stores a database storing identification information of non-text information. The circuitry identifies non-text information in read data including an image. With reference to the database, the circuitry stores in the memory the identified non-text information and identification information corresponding to the identified non-text information in association with each other.

### CROSS-REFERENCE TO RELATED APPLICATIONS

This patent application is based on and claims priority pursuant to 35 U.S.C. § 119(a) to Japanese Patent Application No. 2025-039897, filed on Mar. 13, 2025, in the Japan Patent Office, the entire disclosure of which is hereby incorporated by reference herein.

### BACKGROUND

### Technical Field

The present disclosure relates to an information processing system and an image processing apparatus.

### Related Art

With the advancement of image processing technology, techniques utilizing text recognition such as optical character recognition (OCR) have been widely used. Methods utilizing text recognition technology include the management of business cards, for example.

For instance, there is disclosed a configuration including extraction means, listing means, and imaged data storage means. The extraction means extracts the names of organizations and/or people from text recognized by OCR means. The listing means creates a list of managed people based on the names of the organizations and/or people extracted by the extraction means. The imaged data storage means stores the list created by the listing means and data imaged by imaging means such that the list and the data are associated with each other.

### SUMMARY

The present disclosure described herein provides an information processing system that includes, for example, a memory and circuitry. The memory stores a database storing identification information of non-text information. The circuitry identifies non-text information in read data including an image. With reference to the database, the circuitry stores in the memory the identified non-text information and identification information corresponding to the identified non-text information in association with each other.

The present disclosure described herein further provides an image processing apparatus that includes, for example, circuitry that identifies non-text information in read data including an image. With reference to a database storing identification information of non-text information, the circuitry stores in a memory the identified non-text information and identification information corresponding to the identified non-text information in association with each other.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration example of overall hardware of an information processing system according to an embodiment of the present disclosure;

FIG. 2 is a diagram illustrating a configuration example of hardware included in an image processing apparatus of the information processing system of the embodiment;

FIG. 3 is a diagram illustrating an example of software blocks included in the image processing apparatus of the embodiment;

FIGS. 4A, 4B-1, 4B-2 and 4B-3 are a table and diagrams illustrating a configuration example of an image database of the embodiment;

FIG. 5 is a table illustrating a configuration example of a non-text information database of the embodiment;

FIG. 6 is a flowchart illustrating an example of a process performed by the image processing apparatus of the embodiment;

FIG. 7 is a diagram illustrating an example of an image of the embodiment including a plurality of pages;

FIGS. 8A, 8B, and 8C, FIGS. 9A and 9B, and FIGS. 10A and 10B are diagrams illustrating examples of a screen displayed in the embodiment;

FIGS. 11A, 11B, and 11C are a diagram and tables illustrating a first modified example of the embodiment; and

FIGS. 12A, 12B, 12C-1, and 12C-2 are diagrams and a table illustrating a second modified example of the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

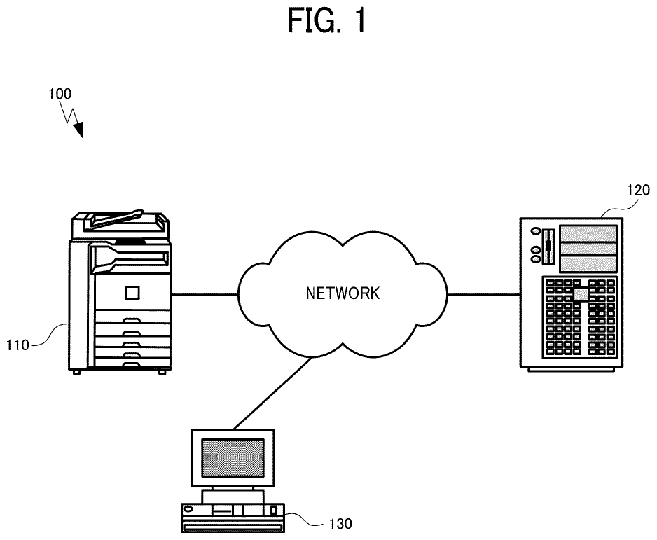

FIG. 1 is a diagram illustrating a schematic configuration of overall hardware of an information processing system 100 according to an embodiment of the present disclosure. FIG. 1 illustrates, as an example, an environment in which an image processing apparatus 110, a server apparatus 120, and a personal computer (PC) terminal 130 are connected to each other via a network such as the Internet or a local area network (LAN). The number of image processing apparatuses 110 or PC terminals 130 is not limited to that in FIG. 1. The number of image processing apparatuses 110 or PC terminals 130 included in the information processing system 100 is not limited to a particular number. The method of connecting the image processing apparatus 110 or the PC terminal 130 to the network may be either wired or wireless.

The image processing apparatus 110 is an information processing apparatus that performs image processing, such as a multifunction peripheral (MFP), for example. The image processing apparatus 110 identifies text information and non-text information included in an image read by a scanner function. The image processing apparatus 110 further manages image data based on the identified information.

The server apparatus 120 is an example of an information processing apparatus that provides a service related to the embodiment. The server apparatus 120 of the embodiment manages and analyzes the image data read by the image processing apparatus 110, for example.

The PC terminal 130 is an example of an information processing apparatus that performs operation and display related to image processing of the embodiment. The PC terminal 130 is an example of the information processing apparatus, and does not limit the embodiment. Therefore, the information processing system 100 may include an information processing apparatus other than the PC terminal 130, such as a smartphone or tablet terminal, for example.

In the embodiment described below, a case of scanning a business card and identifying and managing information included in the business card will be described as an example of the embodiment. However, this example does not limit the embodiment. Therefore, a document other than the business card may be scanned. Further, a method other than scanning may be used to acquire the information of the business card or document.

A hardware configuration of the image processing apparatus 110 will be described.

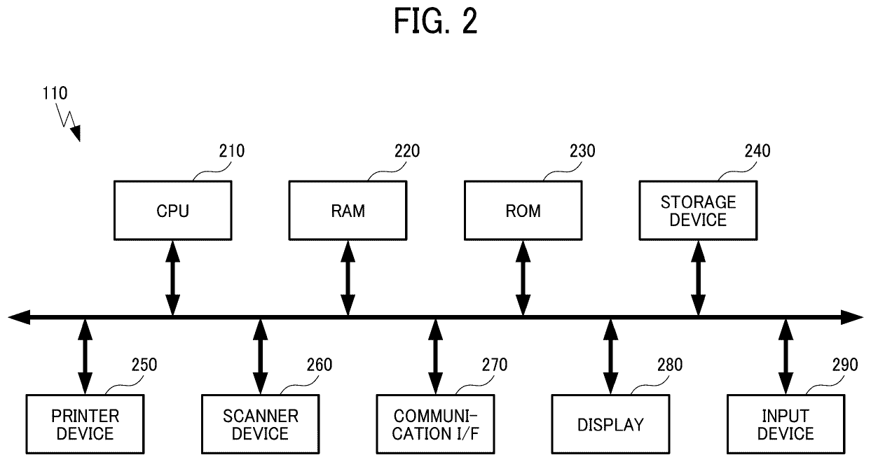

FIG. 2 is a diagram illustrating a configuration of hardware included in the image processing apparatus 110. The image processing apparatus 110 includes a central processing unit (CPU) 210, a random-access memory (RAM) 220, a read-only memory (ROM) 230, a storage device 240, a printer device 250, a scanner device 260, a communication interface (I/F) 270, a display 280, and an input device 290. These hardware components are connected to each other via a bus.

The CPU 210 is a device that executes a program for controlling the operation of the image processing apparatus 110 to perform a particular process. The RAM 220 is a volatile storage device for providing a space for the CPU 210 to execute a program. The RAM 220 is used to store or deploy programs and data. The ROM 230 is a non-volatile storage device for storing programs and firmware executed by the CPU 210.

The storage device 240 is a readable and writable non-volatile storage device for storing an operating system (OS) for causing the image processing apparatus 110 to function, various software, settings information, various data, and so forth. Examples of the storage device 240 include a hard disk drive (HDD) and a solid-state drive (SSD).

The printer device 250 forms an image on a sheet with a laser or inkjet method, for example. The scanner device 260 reads an image of a printed material and converts the image into data. The image processing apparatus 110 makes a copy of a printed material, for example, with the scanner device 260 and the printer device 250 cooperating with each other.

The communication I/F 270 connects the image processing apparatus 110 to the network to enable communication with another apparatus via the network. The communication via the network may be wired or wireless communication. With the communication via the network, various data is transmitted and received with a particular communication protocol such as transmission control protocol/internet protocol (TCP/IP).

The display 280 is a device that displays, for a user, various data and the status of the image processing apparatus 110, for example. An example of the display 280 is a liquid crystal display (LCD). The input device 290 is a device for the user to operate the image processing apparatus 110. An example of the input device 290 is physical buttons such as numerical keys. The display 280 and the input device 290 may be separate devices, or may be a device equipped with a display function and an input function, such as a touch panel display.

Detailed description of hardware configurations of the server apparatus 120 and the PC terminal 130 are omitted here, as the server apparatus 120 and the PC terminal 130 may each have the hardware configuration similar to that of FIG. 2. The server apparatus 120 is not necessarily limited to a so-called external server provided outside the image processing apparatus 110. In an embodiment not using an external server, for example, the server apparatus 120 has the hardware configuration of the image processing apparatus 110 illustrated in FIG. 2 with the printer device 250 and the scanner device 260 removed therefrom.

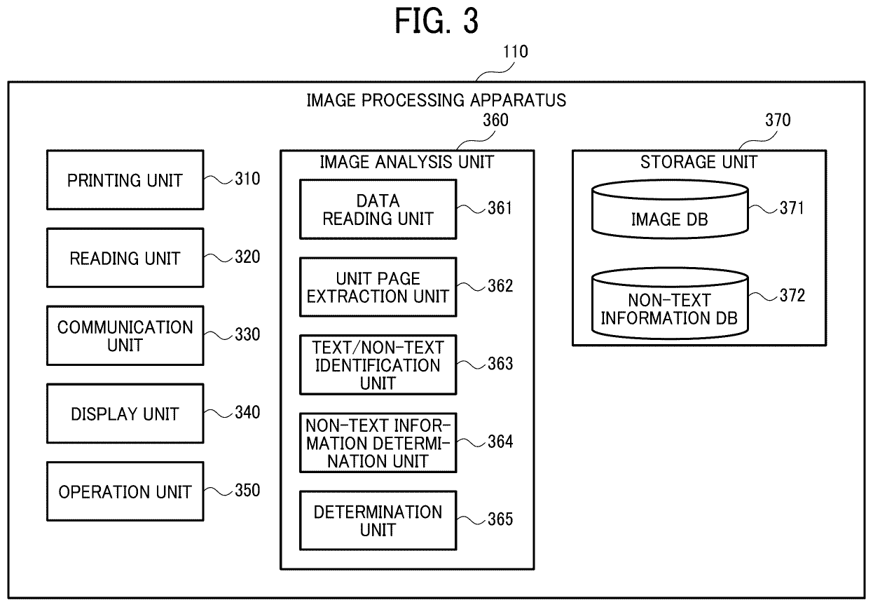

The configuration of the hardware included in the image processing apparatus 110 is as described above. Functional units implemented by the hardware components of the embodiment will be described with FIG. 3.

FIG. 3 is a diagram illustrating software blocks included in the image processing apparatus 110. As illustrated in FIG. 3, the image processing apparatus 110 includes functional units including a printing unit 310, a reading unit 320, a communication unit 330, a display unit 340, an operation unit 350, an image analysis unit 360, and a storage unit 370.

Details of the functional units will be described below.

The printing unit 310 controls the operation of the printer device 250 to form an image on a sheet and output the sheet to perform a printing process. The printing unit 310 is an example of printing means. The printing unit 310 may perform the printing process based on a print job transmitted from the PC terminal 130, or may perform a printing process based on a document read by the scanner device 260 (i.e., a copying process).

The reading unit 320 controls the operation of the scanner device 260 to read an image printed on a sheet, for example. The reading unit 320 is an example of reading means. The reading unit 320 outputs the read image as image data. The image data output by the reading unit 320 may be stored in the storage unit 370, or may be transmitted to the server apparatus 120 or the PC terminal 130 via the network to be stored in the information processing apparatus.

The communication unit 330 controls the operation of the communication I/F 270 to communicate with another information processing apparatus via the network. The communication unit 330 is an example of communication means. The communication unit 330 transmits and receives image data to and from the server apparatus 120 or the PC terminal 130, for example.

The display unit 340 controls the operation of the display 280 to display various data and an operation screen, for example. The display unit 340 is an example of display means. The display unit 340 displays data related to the read image in a list, for example. The display unit 340 further displays the data based on filtering with a user-selected item.

The operation unit 350 receives, via the input device 290, an operation performed by the user to operate the image processing apparatus 110. The operation unit 350 is an example of operation means. The operation unit 350 performs an operation of selecting an action in the printing process, the reading process, the display process, or the image analysis process, for example.

The image analysis unit 360 analyzes an image to be processed. The image analysis unit 360 is an example of analysis means. The image analysis unit 360 includes functional units including a data reading unit 361, a unit page extraction unit 362, a text/non-text identification unit 363, and a non-text information determination unit 364.

The data reading unit 361 reads data including an image to be analyzed. The data reading unit 361 is an example of reading means. The data reading unit 361 reads the data of the image scanned by the reading unit 320, for example. However, this example does not limit the embodiment. Therefore, the data reading unit 361 may read the data of an image to be analyzed from the server apparatus 120 or the PC terminal 130 via the network, or may read the data of an image captured by a camera or the like. Further, the data reading unit 361 may read the data of an image from various types of storage media inserted in the image processing apparatus 110, such as a secure digital (SD) card and a universal serial bus (USB) memory. The data read by the data reading unit 361 is not limited to a particular format, and may be in an image file such as joint photographic experts group (JPEG), portable network graphics (PNG), or bitmap or in a portable document format (PDF) file, for example.

The unit page extraction unit 362 extracts page by page the data of the image read by the data reading unit 361. The unit page extraction unit 362 is an example of extraction means. If the data read by the data reading unit 361 includes a plurality of pages, for example, the unit page extraction unit 362 extracts the data in page units. Further, if one image includes a plurality of pages (e.g., if a plurality of business cards are laid out and read in one scan), the unit page extraction unit 362 extracts the data by dividing the pages in the image (e.g., so that each page includes one business card).

The text/non-text identification unit 363 identifies text information and non-text information for each page in the image read by the data reading unit 361. The text/non-text identification unit 363 is an example of identification means. The text/non-text identification unit 363 identifies the text information included in the image through an OCR process, for example. The text/non-text identification unit 363 further identifies additional information in the image other than the text information as the non-text information. For example, the text/non-text identification unit 363 identifies a logo, icon, or two-dimensional code in the image other than a character string as the non-text information. The text/non-text identification unit 363 further identifies information such as the size and orientation of the image, for example, as the non-text information.

The non-text information determination unit 364 determines whether the non-text information identified by the text/non-text identification unit 363 is identical to non-text information included in a database. The non-text information determination unit 364 is an example of determination means. The non-text information determination unit 364 uses a pattern matching process, for example, to compare the identified non-text information with the non-text information stored in the database and determine whether the identified non-text information is identical to the stored non-text information. The database referred to in the determination process performed by the non-text information determination unit 364 may be a non-text information database (DB) 372 of the storage unit 370, for example. However, the non-text information DB 372 does not limit the embodiment. For example, therefore, the non-text information determination unit 364 may refer to a database in the server apparatus 120 or the PC terminal 130 via the network, or may refer to a database in a storage medium inserted in the image processing apparatus 110, such as an SD card or USB memory.

The image analysis unit 360 may include a determination unit 365 as necessary. The determination unit 365 makes a determination by comparing or examining the non-text information and the additional information other than the non-text information. The determination unit 365 is an example of determination means. The determination unit 365 determines, for example, whether the non-text information included in the image matches or fits the text information (including information of a uniform resource locator (URL) obtained through the Internet and information stored in a two-dimensional code, as well as information directly acquired through OCR such as company name and telephone number, for example) and whether these types of information correspond to each other.

The non-text information determination unit 364 and the determination unit 365 may use a so-called artificial intelligence (AI) process using machine learning or deep learning to make determinations related to the non-text information and other determinations.

The storage unit 370 controls the operation of the storage device 240 to perform various processes related to the storage of information (e.g., the storage and reading of information). The storage unit 370 is an example of storage means. The storage unit 370 includes a storage area for an image DB 371 and the non-text information DB 372. The storage unit 370 stores, in the image DB 371, information such as the text information and the non-text information of the image analyzed by the image analysis unit 360, for example. The storage unit 370 further updates the non-text information DB 372 based on the image analyzed by the image analysis unit 360.

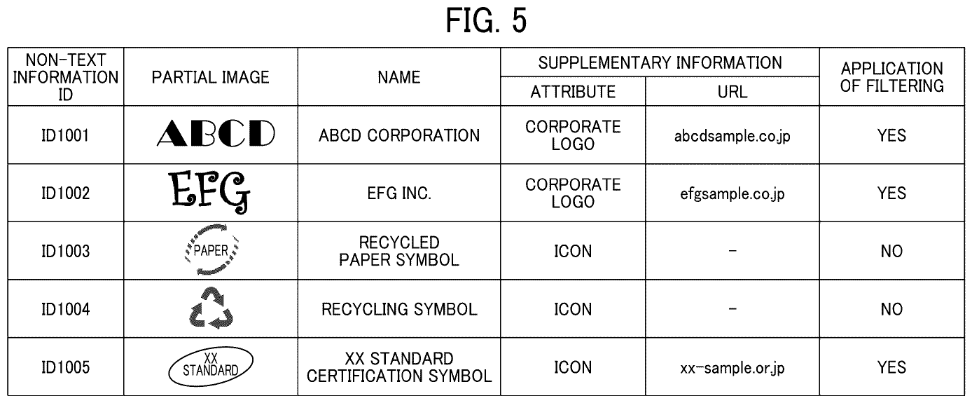

The databases included in the storage unit 370 will be described with reference to FIGS. 4A, 4B-1, 4B-2, and 4B-3 and FIG. 5. FIGS. 4A, 4B-1, 4B-2, and 4B-3 are a table and diagrams illustrating a configuration example of the image DB 371 of the embodiment. FIG. 5 is a table illustrating a configuration example of the non-text information DB 372 of the embodiment.

The image DB 371 of FIGS. 4A, 4B-1, 4B-2, and 4B-3 will be described first.

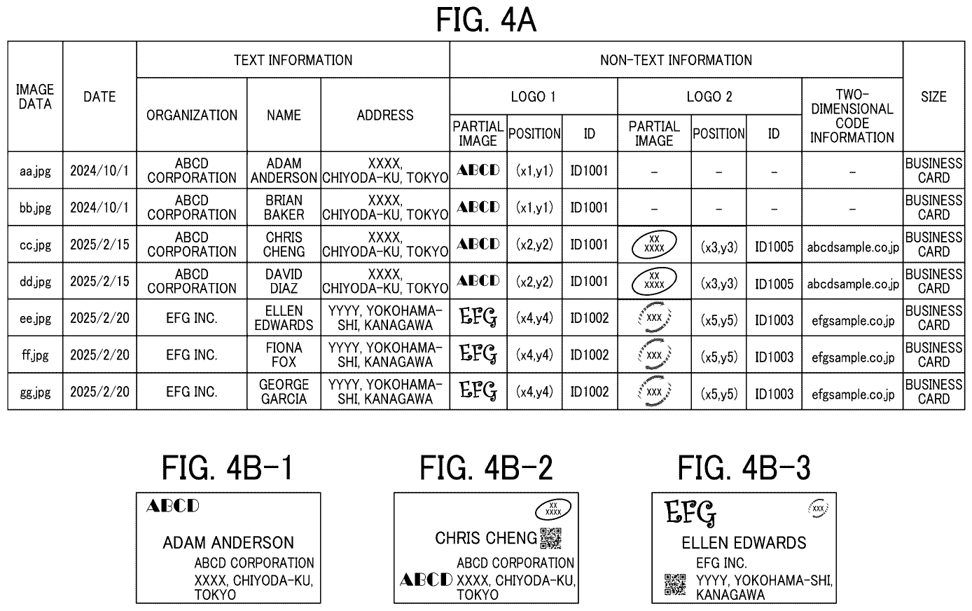

FIG. 4A illustrates an example of data stored in the image DB 371. FIGS. 4B-1, 4B-2, and 4B-3 illustrate examples of a read business card. As illustrated in FIG. 4A, the file name of the image data, the date of acquisition of the image, the text information, the non-text information, and the size of the image are stored in the image DB 371 in association with each other. If a business card is read, the text information includes organization, name, and address, for example. The non-text information includes information such as a logo or two-dimensional code included in the business card. As for the logo of the non-text information, the image DB 371 may store the position (coordinates) of the logo in the business card and an identifier (ID) as identification information for identifying the logo, for example.

If the business card illustrated in FIG. 4B-1 is read, for example, character strings “ADAM ANDERSON,” “ABCD CORPORATION,” and “XXXX, CHIYODA-KU, TOKYO” are identified as the text information and stored in the image DB 371. In this case, an image included in the image of the business card (hereinafter referred to as the partial image) is identified as the non-text information, and a logo “ABCD” is stored in the image DB 371. The identified information is therefore stored in the image DB 371 in association with a file name “aa.jpg,” as illustrated in FIG. 4A.

If the business card illustrated in FIG. 4B-2 or 4B-3 is read, the read image data includes a plurality of partial images. Therefore, the respective positions and IDs of the partial images are stored. There is no maximum limit to the number of partial images storable in the image DB 371. Further, if the business card illustrated in FIG. 4B-2 or 4B-3 is read, information indicated by a two-dimensional code included in the image of the business card may be read and stored in the image DB 371.

As illustrated in FIG. 4A, the text information and the non-text information of the read image are stored in association with each other, which improves image searchability, facilitating easier management of business cards, for example.

The non-text information DB 372 of FIG. 5 will be described.

As illustrated in FIG. 5, an ID for identifying the non-text information, the partial image, the name, supplementary information, and a flag indicating the application or non-application of filtering are stored in association with each other. “NON-TEXT INFORMATION ID,” which is the ID for identifying the non-text information, corresponds to the information stored in the item “NON-TEXT INFORMATION” of the image DB 371 illustrated in FIG. 4A. “PARTIAL IMAGE” is the partial image representing the non-text information. “NAME,” which is a name indicating the non-text information, may be any name given by the user, for example. “SUPPLEMENTARY INFORMATION,” which is supplementary information of the partial image, includes the type such as the attribute and the URL of a website related to the partial image, for example. “APPLICATION OF FILTERING” is a flag indicating whether or not to apply filtering when displaying the data of image in a list. In the example of FIG. 5, if a partial image such as “ABCD” or “EFG” representing a corporate logo is used in the filtering when searching for and displaying business cards including the partial image, for example, the business cards of a particular company are extracted. It is therefore preferable to set the filtering flag to “YES.” A recycled paper symbol or a recycling symbol in the example of FIG. 5, on the other hand, is less useful in terms of searching for a particular business card. In this case, therefore, it is preferable to set the filtering flag to “NO.” With the filtering flag thus set, the convenience in image search is improved.

Referring back to FIG. 3, the above-described software blocks correspond to functional units implemented by the CPU 210 executing a program to cause the hardware components to function. The functional units described in the embodiment may be implemented entirely by software, or may be implemented entirely or partially by hardware that provides functions equivalent to those of the functional units.

Not all the above-described functional units may be included in the image processing apparatus 110 with the configuration illustrated in FIG. 3. As another example, part of the functional units illustrated in FIG. 3 may be included in the server apparatus 120 or the PC terminal 130, or may be implemented by the cooperation between the image processing apparatus 110, the server apparatus 120, and the PC terminal 130.

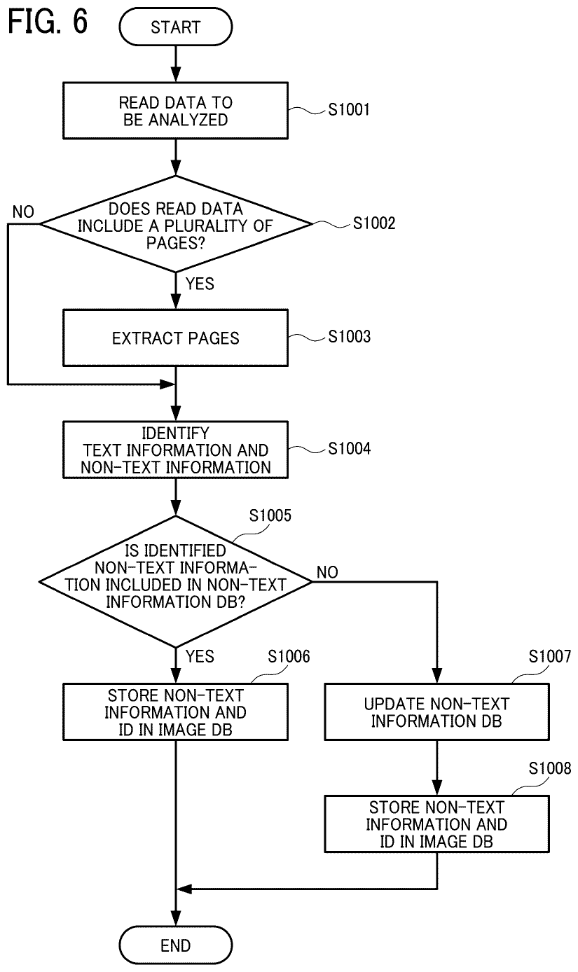

A process performed by the above-described functional units will be described with reference to FIG. 6. FIG. 6 is a flowchart illustrating a process performed by the image processing apparatus 110.

At step S1001, the data reading unit 361 reads the data of an image to be analyzed. The data may be the data of a scanned image, the data of an image acquired from an external apparatus such as the server apparatus 120 or the PC terminal 130, or the data of an image stored in a recording medium inserted in the image processing apparatus 110, for example.

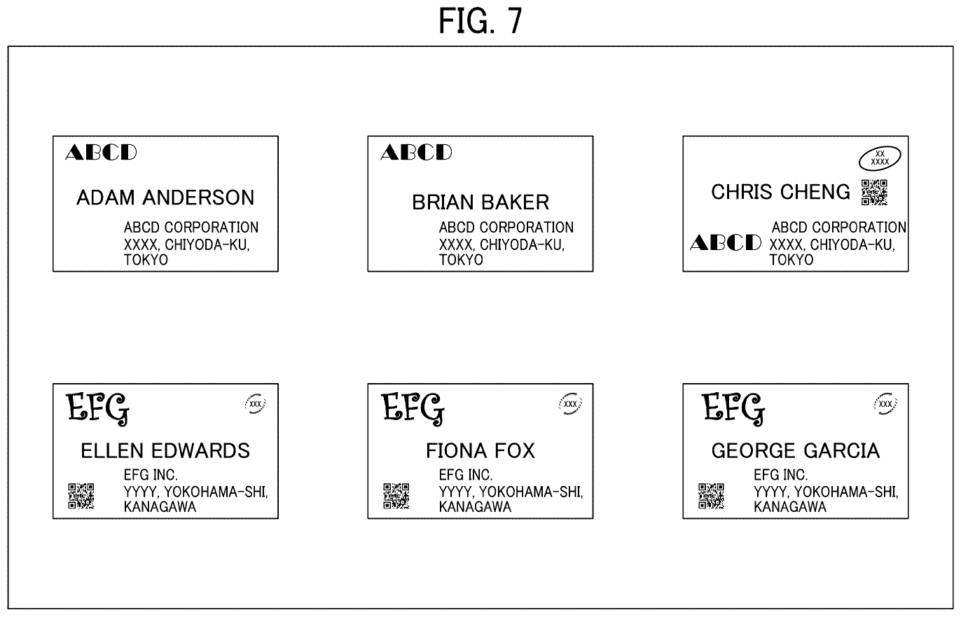

At step S1002, the process branches based on whether the image read at step S1001 includes a plurality of pages. Herein, an image including a plurality of pages may be an image configured as in FIG. 7, for example, as well as a simple multiple-page image in a single image file.

FIG. 7 is a diagram illustrating an example of an image of the embodiment including a plurality of pages. In the example illustrated in FIG. 7, a plurality of business cards are read in a single reading process; the plurality of business cards (corresponding to pages) are included in a single image. In the case of such an image, the image analysis unit 360 extracts and analyzes the pages (respective business cards) from the image to manage information for each of the business cards. If the read image includes a plurality of pages (YES at step S1002), therefore, the process proceeds to step S1003.

At step S1003, the unit page extraction unit 362 extracts the pages from the image. To process the image illustrated in FIG. 7, for example, the unit page extraction unit 362 extracts each of six business cards included in the image. The following steps of the process are performed for each of the extracted pages.

If the read image does not include a plurality of pages (NO at step S1002), i.e., if the read image includes a single page, as illustrated in FIG. 4B-1, 4B-2, or 4B-3, the process proceeds to step S1004 without the page extraction process taking place.

At step S1004, the text/non-text identification unit 363 identifies text information and non-text information in the image to be processed. The text/non-text identification unit 363 applies a character recognition processing technique such as OCR to the image to identify an area of a character string and an area of information other than the character string (i.e., a partial image) in the image. Herein, a character string used as a logo or symbol, such as the partial image “ABCD” or “EFG” in FIG. 5, for example, is included in the information other than the character string. The area of the character string is identified as the text information, and the area of the partial image is identified as the non-text information.

At step S1005, the process branches based on whether the non-text information identified in the process of step S1004 is included in the non-text information DB 372. At step S1005, the non-text information determination unit 364 refers to the non-text information DB 372 to determine whether the identified non-text information is included in the non-text information DB 372. If the non-text information is included in the non-text information DB 372 (YES at step S1005), the process proceeds to step S1006. For example, if the business card of FIG. 4B-1 is read, the read image includes the partial image “ABCD,” which is included in the non-text information DB 372 (see FIG. 5). It is therefore determined that the non-text information is included in the non-text information DB 372. If the non-text information is not included in the non-text information DB 372 (NO at step S1005), the process proceeds to step S1007. For example, if non-text information not included in the non-text information DB 372 in FIG. 5 is identified (e.g., if a logo “HIJ” is identified), it is determined that the non-text information (“HIJ”) is not included in the non-text information DB 372.

At step S1006, the storage unit 370 stores, in the image DB 371, the non-text information identified at step S1004 and the ID of the non-text information stored in the non-text information DB 372 such that the non-text information and the ID are associated with each other. For example, if the business card of FIG. 4B-1 is read in the example of FIGS. 4A to 5, an ID “ID1001” for identifying the partial image “ABCD” in the non-text information DB 372 is stored in the image DB 371 in association with the partial image “ABCD” (see FIG. 4A). The image processing apparatus 110 then completes the process.

If the process branches to step S1007 from step S1005, the storage unit 370 registers the identified non-text information in the non-text information DB 372 at step S1007 to update the non-text information DB 372. In the process of step S1007, therefore, the identified non-text information is assigned with a new ID and registered in the non-text information DB 372. The process of step S1007 may not necessarily take place. For example, the update of the non-text information DB 372 may not be desired in some cases. If the process branches to NO at step S1005 in this case, the process of step S1007 may be switched off to skip the update.

At step S1008, the storage unit 370 stores, in the image DB 371, the non-text information identified at step S1004 and the ID of the non-text information stored in the non-text information DB 372 (i.e., the ID newly assigned at step S1007) such that the non-text information and the ID are associated with each other. The image processing apparatus 110 then completes the process.

With the process illustrated in FIG. 6, the image processing apparatus 110 manages the file of the image data and the identified information in association with each other, facilitating easier image search.

The process illustrated in FIG. 6 includes the process of determining whether the non-text information is included in the non-text information DB 372. However, this process does not limit the embodiment. Therefore, the non-text information DB 372 may not necessarily be referred to. For example, information related to the partial image may be acquired through image search on the Internet or by reference to a database provided by an extraneous resource.

Image search based on the databases managed with the process of FIG. 6 will be described below.

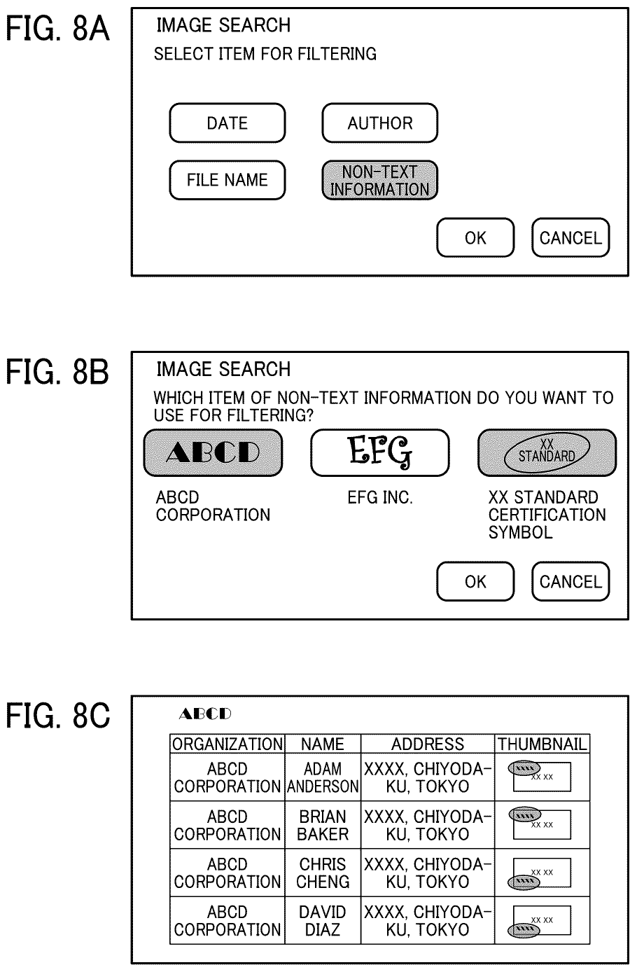

FIGS. 8A, 8B, and 8C, FIGS. 9A and 9B, and FIGS. 10A and 10B are diagrams illustrating examples of a screen displayed in the embodiment. In the following description, the image DB 371 of FIG. 4A and the non-text information DB 372 of FIG. 5 will be referred to where necessary.

To search for an image in the embodiment, a filtering condition may be specified to display a list of images meeting the condition. For example, the filtering may be performed with an item such as “DATE,” “AUTHOR,” “FILE NAME,” or “NON-TEXT INFORMATION,” as illustrated in FIG. 8A.

If “NON-TEXT INFORMATION” is selected on the screen of FIG. 8A as an item for the filtering, the screen of FIG. 8A transitions to the screen of FIG. 8B. The screen of FIG. 8B is for selecting which item of the non-text information is to be used in the filtering. For example, the display unit 340 displays the screen illustrated in FIG. 8B by referring to the non-text information DB 372. On the screen of FIG. 8B, items of the non-text information with the item “APPLICATION OF FILTERING” in the non-text information DB 372 set to “YES” (see FIG. 5) are selectably displayed. In the embodiment example described here, the filtering flag is set to “YES” for “ABCD CORPORATION,” “EFG INC. ,” and “XX STANDARD CERTIFICATION SYMBOL” in the non-text information DB 372 of FIG. 5. Therefore, the non-text information of “ABCD CORPORATION,” the non-text information of “EFG INC. ,” and the non-text information of “XX STANDARD CERTIFICATION SYMBOL” are selectably displayed, as illustrated in FIG. 8B. As well as the non-text information items (the partial images), names corresponding thereto may also be displayed on the screen of FIG. 8B. The displayed names may be the names stored in the item “NAME” of the non-text information DB 372. The names may be set as desired by the user, for example.

If “ABCD CORPORATION” is selected on the screen of FIG. 8B, the screen of FIG. 8B transitions to the screen of FIG. 8C. The screen of FIG. 8C displays a list of search results based on the filtering with the item selected on the screen of FIG. 8B. For example, with reference to the image DB 371, the display unit 340 retrieves data including the ID corresponding to “ABCD CORPORATION” (“ID1001” in FIG. 4A) and displays the list illustrated in FIG. 8C. The list of FIG. 8C includes data based on the image DB 371 of FIG. 4A (e.g., “ORGANIZATION,” “NAME,” and “ADDRESS”).

The list of search results may further display thumbnail images of the corresponding images, as illustrated in FIG. 8C. Each of the thumbnail images may be displayed with the location of the non-text information in the thumbnail image highlighted. For example, in FIG. 8C, the partial image “ABCD” is displayed as marked up in the thumbnail image. With the list of search results thus displayed, the user readily grasps the search results.

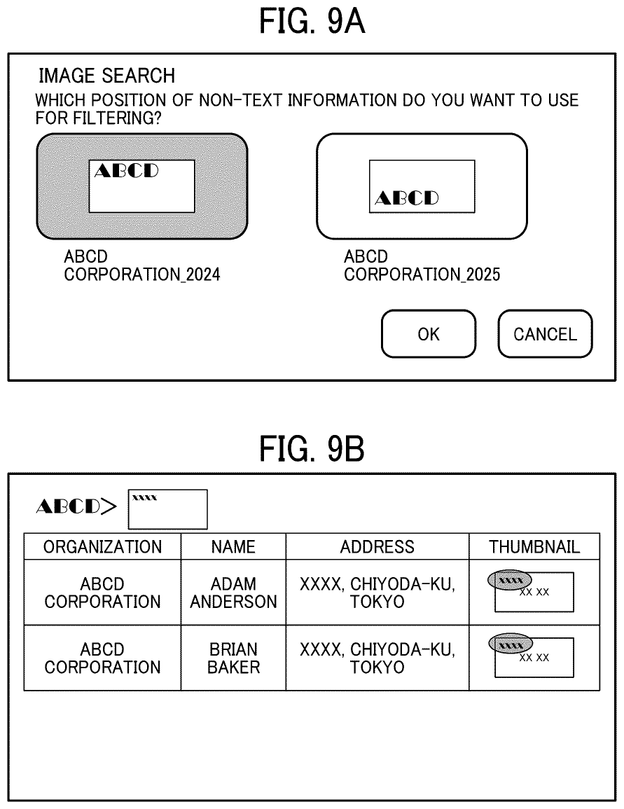

The filtering of the non-text information may be performed based on the position of the non-text information, for example. For instance, after “ABCD CORPORATION” is selected on the screen of FIG. 8B, the screen of FIG. 8B may transition to the screen of FIG. 9A. The screen of FIG. 9A is displayed to allow the user to select the position of the non-text information to be used in the filtering. For example, business cards of the same company “ABCD CORPORATION” may have different positions of the logo depending on the time of printing the business card, as illustrated in FIGS. 4B-1 and 4B-2. As illustrated in FIG. 9A, therefore, the filtering may be performed with a condition such as “the images of business cards with the logo located at the upper-left corner thereof” or “the images of business cards with the logo located at the lower-left corner thereof.” The screen of FIG. 9A may also display different names for different positions of the non-text information, such as “ABCD CORPORATION_2024” and “ABCD CORPORATION_2025.”

If the filtering with the condition “the business cards with the logo located at the upper-left corner thereof” is selected on the screen of FIG. 9A, the screen FIG. 9A transitions to the screen of FIG. 9B. With reference to the image DB 371, the display unit 340 retrieves the data of business cards with the partial image “ABCD” located at the upper-left corner thereof (coordinates x1, y1 in FIG. 4A) from the data of the business cards of ABCD CORPORATION, and displays the list illustrated in FIG. 9B, for example. The filtering is thus performed based on the position of the non-text information, improving the convenience for the user in image search and management.

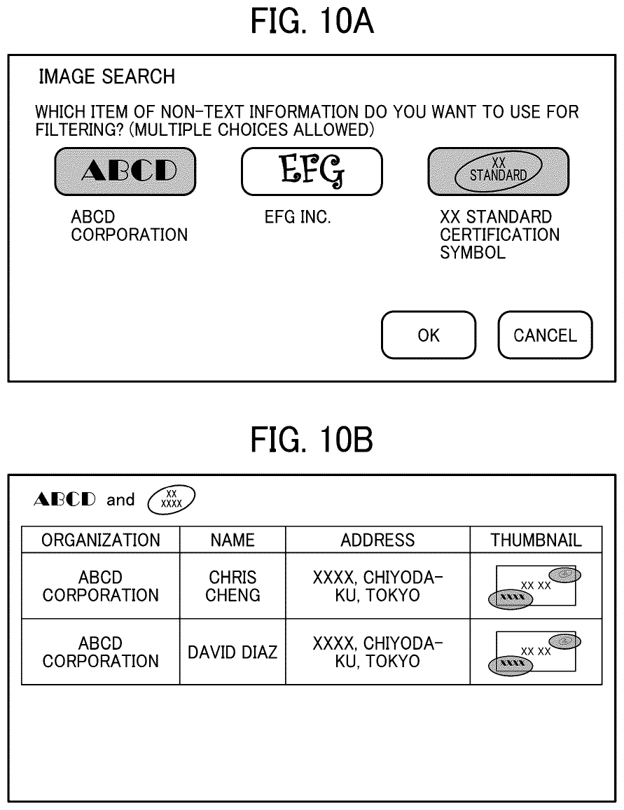

The filtering of the non-text information may also be performed based on multiple items of the non-text information, for example. For instance, after “NON-TEXT INFORMATION” is selected on the screen of FIG. 8A as the item for the filtering, the screen of FIG. 8A may transition to the screen of FIG. 10A. The screen of FIG. 10A is configured to allow the user to select multiple items of the non-text information for the filtering.

If “ABCD CORPORATION” and “XX STANDARD CERTIFICATION SYMBOL” are selected on the screen of FIG. 10A, the screen of FIG. 10A transitions to the screen of FIG. 10B. With reference to the image DB 371, the display unit 340 retrieves data including both the ID corresponding to “ABCD CORPORATION” (“ID1001”) and an ID corresponding to “XX STANDARD CERTIFICATION SYMBOL” (“ID1005” in FIG. 4A), and displays the list illustrated in FIG. 10B, for example. The filtering is thus performed based on multiple items of the non-text information, improving the convenience for the user in image search and management.

The configuration of the embodiment described above does not limit the embodiment. The embodiment may have a configuration according to a modified example.

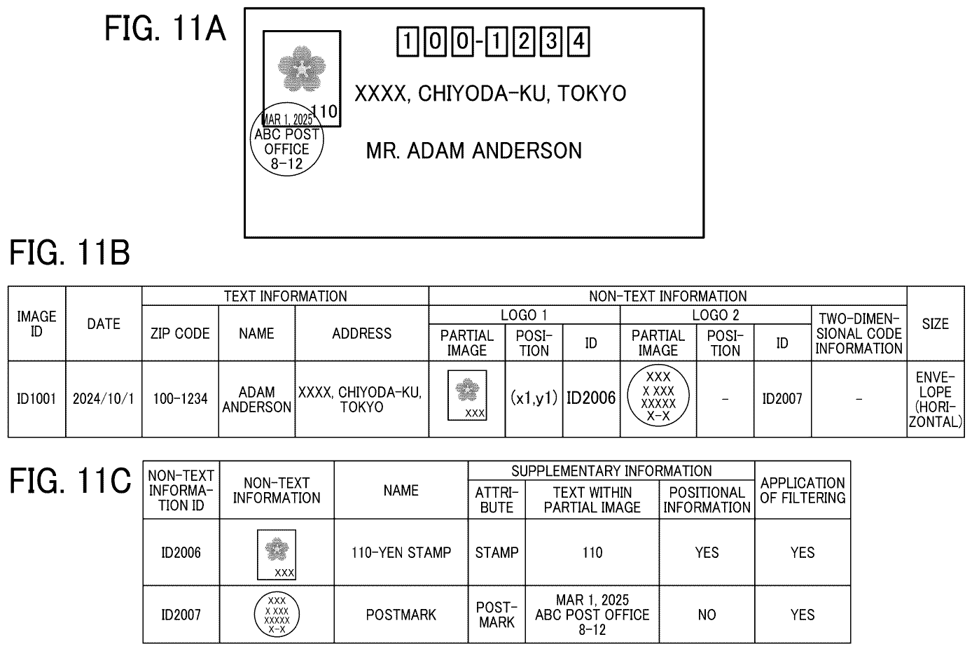

Modified examples of the embodiment will be described below with reference to FIGS. 11A, 11B, and 11C and FIGS. 12A, 12B, 12C-1, and 12C-2. FIGS. 11A, 11B, and 11C are a diagram and tables illustrating a first modified example of the embodiment. FIGS. 12A, 12B, 12C-1, and 12C-2 are diagrams and a table illustrating a second modified example of the embodiment.

The first modified example of FIGS. 11A to 11C will be described first.

In the first modified example, the object to be managed is the address side of a postcard or envelope, for example, unlike the business card in the above-described embodiment. FIG. 11A illustrates an example of the address side of the envelope to be read and managed in the first modified example. The address side normally includes the zip code, address, and name of an addressee, as illustrated in FIG. 11A. Further, a posted envelope normally has a stamp (postage stamp) on the address side and a postmark stamped overlapping the stamp, as illustrated in FIG. 11A.

In the first modified example, when the address side such as that illustrated in FIG. 11A is read, the text/non-text identification unit 363 identifies the zip code, the address, and the name as the text information and identifies the stamp and the postmark and the non-text information. Herein, the stamp is placed at a particular position on the address side. The postmark, on the other hand, is stamped near the stamp but not necessarily at the same position in all mails. Therefore, there is not much need for filtering based on the position of the postmark, and thus positional information of the postmark may not be acquired. In the image DB 371, therefore, the partial image of the stamp is associated with positional information thereof, while the partial image of the postmark may not be associated with positional information thereof, as illustrated in FIG. 11B. As for the partial image of the postmark in the non-text information DB 372, whether or not to acquire the positional information may be registered as “NO” in “SUPPLEMENTARY INFORMATION,” as illustrated in FIG. 11C. If the non-text information is a postmark, therefore, the partial image of the postmark is not associated with the positional information, as illustrated in FIG. 11B. Whether or not to acquire the positional information in “SUPPLEMENTARY INFORMATION” may be set as desired by the user. For example, the settings may be made to acquire the positional information as necessary even in the case of the partial image of the postmark.

In the image DB 371 of the first modified example, third information other than the text information and the non-text information, such as the size and orientation of the read image, may be identified and registered as size information. The size may be identified by employing an existing method such as detecting an edge of a target object (document) with a scanner, for example. In the example illustrated in FIG. 11A, a horizontally long mail is read. Therefore, the orientation of the image may be registered in the image DB 371 as the size information, such as “ENVELOPE (HORIZONTAL),” as illustrated in FIG. 11B. For example, the orientation of characters included in the text information may be recognized through OCR, and the orientation of the image may be determined based on the orientation of the characters and the vertical and horizontal sizes of the image. Alternatively, the orientation of the image may be determined based on the orientation of the partial image of the non-text information (the orientation of the stamp in the present example). Further, the orientation of the image may be determined by the determination unit 365 based on a combination of the orientation of the characters, the vertical and horizontal sizes of the image, and the orientation of the partial image. This configuration enables automatic name setting by the determination unit 365 or manual name setting by the user (e.g., the setting of a name such as “mini letter,” “regular mail,” or “postcard”) based on the size and orientation information of the image and the information of the partial image forming the non-text information, for example, thereby enabling filtering using the set name. In this case, the positional information (the position of the stamp in the read image in the present example) is utilized as the information of the partial image of the non-text information, enabling appropriate settings.

The partial image of the identified non-text information may include a character string (text). The text within the partial image may be registered in the supplementary information of the non-text information DB 372. For example, as illustrated in FIG. 11C, the partial image of the stamp includes a character string “110,” which indicates the value of the stamp. Therefore, the non-text information may be registered in association with “110” as the text within the partial image. Further, the partial image of the postmark includes character strings indicating the posting date, the name of the post office, and the time period, for example. Therefore, character strings such as “Mar. 1, 2025,” “ABC POST OFFICE,” and “8-12” may be registered as the text within the partial image. With the character strings in the non-text information thus recognized through OCR, for example, image searchability is improved. Further, the determination unit 365 may make a particular determination based on the partial image of the identified non-text information or the information of the character string included in the partial image (e.g., “110” indicating the value of the stamp), the text information (e.g., address and name information), and other supplementary information (information registered in association with the read data, such as size and weight information of the read object). Then, the non-text information may be registered in association with the thus-made determination (e.g., paid right amount, underpaid, or overpaid). Further, filtering may be performed based on the registered determination, for example, to sort the data of undeliverable mails and take an action such as checking and correcting the data or simultaneously sending messages to those concerned.

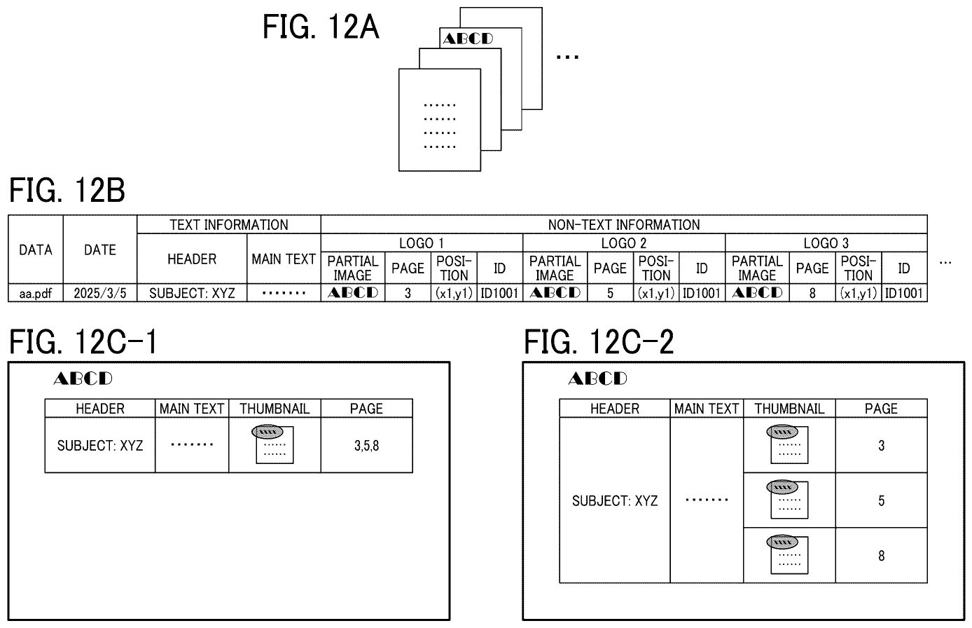

A second modified example of FIGS. 12A to 12C-2 will be described.

In the second modified example, document data in a file such as a PDF file includes a plurality of pages. For example, if the data to be read includes a plurality of pages (e.g., data in a PDF file), as illustrated in FIG. 12A, the plurality of pages may include a page with the non-text information and a page without the non-text information. In this case, the page number may be registered in the item “NON-TEXT INFORMATION” of the image DB 371.

For example, when a document including a plurality of pages such as that illustrated in FIG. 12A is read, the plurality of pages may include a page with the non-text information and a page without the non-text information. In this case, the non-text information and the page number of the page including the non-text information may be registered in association with each other in the image DB 371 of the second modified example, as illustrated in FIG. 12B. FIG. 12B illustrates an example of the image DB 371 storing the non-text information “ABCD,” which is included in the third, fifth, and eighth pages.

If a document including the non-text information in a plurality of pages is searched through based on the filtering with the non-text information, a list screen such as that illustrated in FIG. 12C-1 or 12C-2, for example, is displayed. On the screen illustrated in FIG. 12C-1, for instance, the list displays an item of pages including the non-text information, indicating that the non-text information is included in the third, fifth, and eight pages, which are associated with one thumbnail image. Alternatively, the list may display respective thumbnail images associated with the pages. For example, the list may separately display a thumbnail image of the third page, a thumbnail image of the fifth page, and a thumbnail image of the eighth page, as illustrated in FIG. 12C-2.

The above-described embodiment of the present disclosure provides an information processing system, an image processing apparatus, a method, and a non-transitory recording medium that improve the convenience in managing images including non-text information.

The functionality of the above-described embodiment of the present disclosure may be implemented by a device-executable program described in a programming language such as C, C++, C #, or Java (registered trademark). The program of the embodiment may be distributed as stored in a device-readable recording medium such as an HDD, a compact disc-read-only memory (CD-ROM), a magneto-optical (MO) disk, a digital versatile disc (DVD), a flexible disk, an electrically erasable programmable read-only memory (EEPROM), or an erasable programmable read-only memory (EPROM). The program of the embodiment may also be transmitted via a network in a format compatible with another device.

The functionality of the elements disclosed herein may be implemented using circuitry or for circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present disclosure includes the following aspects.

According to a first aspect, an information processing system includes identification means and storage means. The identification means identifies non-text information in read data including an image. With reference to a database storing identification information of non-text information, the storage means stores the identified non-text information and identification information corresponding to the identified non-text information in association with each other.

According to a second aspect, in the information processing system of the first aspect, the identification means identifies text information in the read data, and the storage means stores the identified text information in association with the identified non-text information.

According to a third aspect, the information processing system of the first aspect further includes display means for displaying a list based on information stored in the storage means.

According to a fourth aspect, in the information processing system of the third aspect, the display means displays the list based on filtering the non-text information.

According to a fifth aspect, in the information processing system of the fourth aspect, the database includes an item for setting whether to filter the non-text information.

According to a sixth aspect, in the information processing system of the fourth aspect, the display means displays, in the list, a thumbnail image including the filtered non-text information.

According to a seventh aspect, in the information processing system of the sixth aspect, the display means displays the thumbnail image with the non-text information highlighted.

According to an eighth aspect, the information processing system of one of the first to seventh aspects further includes extraction means for extracting one or more pages included in the read data. The identification means identifies the non-text information for each of the one or more pages extracted by the extraction means.

According to a ninth aspect, in the information processing system of one of the first to eighth aspects, the identification means identifies a position of the non-text information. The storage means stores information of the position identified by the identification means in association with the non-text information.

According to a tenth aspect, in the information processing system of one of the first to ninth aspects, the identification means identifies information indicated by a two-dimensional code as the non-text information included in the read data. The storage means stores the information indicated by the two-dimensional code.

According to an eleventh aspect, in the information processing system of one of the first to tenth aspects, the database stores an image of the non-text information in association with the identification information. The information processing system further includes determination means for determining whether the image of the non-text information is identical to the identified non-text information.

According to a twelfth aspect, in the information processing system of the eleventh aspect, the determination means uses a pattern matching process to determine whether the image of the non-text information is identical to the identified non-text information.

According to a thirteenth aspect, in the information processing system of one of the first to twelfth aspects, the data is image data or document data.

According to a fourteenth aspect, the information processing system of the second aspect further includes determination means for making a determination with the non-text information. The storage means stores the determination made by the determination means in association with the non-text information.

According to a fifteenth aspect, in the information processing system of the fourteenth aspect, the determination means makes the determination based on, in addition to the non-text information, at least one of the text information, second non-text information different from the non-text information, and third information other than the non-text information and the text information.

According to a sixteenth aspect, in the information processing system of the fifteenth aspect, the determination means determines whether the text information and the third information correspond to each other based on at least the non-text information and the third information other than the non-text information and the text information. The third information is related to read image data.

According to a seventeenth aspect, in the information processing system of the fifteenth or sixteenth aspect, the third information is external information acquired through the Internet.

According to an eighteenth aspect, in the information processing system of one of the fourteenth to seventeenth aspects, the information other than the non-text information includes contact information. The contact information is filterable based on the determination made by the determination means. The information processing system further includes contact means for contacting a party included in the contact information and selected through filtering.

According to a nineteenth aspect, in the information processing system of the third aspect, the identification means identifies a size of a read object in the read data. The display means displays the list based on filtering with a combination of information of the size identified by the identification means and the non-text information.

According to a twentieth aspect, the information processing system of the nineteenth aspect receives manual setting of a name for the combination of the information of the size identified by the identification means and the non-text information.

According to a twenty-first aspect, the information processing system of the nineteenth aspect further includes a determination unit that compares or examines the information of the size identified by the identification means and the non-text information to make a determination. The determination unit automatically sets a name for the combination of the information of the size identified by the identification means and the non-text information.

According to a twenty-second aspect, in the information processing system of one of the nineteenth to twenty-first aspects, the identification means identifies a position of the non-text information in the image. The non-text information includes information related to a position of the non-text information in the read object.

According to a twenty-third aspect, in the information processing system of the twenty-second aspect, whether to include the information related to the position of the non-text information in a condition for the filtering is selectable.

According to a twenty-fourth aspect, in the information processing system of one of the nineteenth to twenty-first aspects, the non-text information includes first non-text information and second non-text information. The identification means identifies a position of the non-text information. The first non-text information includes information related to a position of the first non-text information in the read object. The second non-text information lacks information related to a position of the second non-text information in the read object.

According to a twenty-fifth aspect, an image processing apparatus includes identification means and storage means. The identification means identifies non-text information in read data including an image. With reference to a database storing identification information of non-text information, the storage means stores the identified non-text information and identification information corresponding to the identified non-text information in association with each other.

According to a twenty-sixth aspect, the image processing apparatus of the twenty-fifth aspect further includes reading means for reading an image. The identification means identifies the non-text information in data of the image read by the reading means. The reading means is a scanner, for example.

According to a twenty-seventh aspect, in the image processing apparatus of the twenty-fifth or twenty-sixth aspect, the database is provided from an extraneous resource outside the image processing apparatus.

According to a twenty-eighth aspect, a method includes reading data including an image, identifying non-text information in the data read in the reading, and with reference to a database storing identification information of non-text information, storing the non-text information identified in the identifying and identification information corresponding to the identified non-text information in association with each other.

According to a twenty-ninth aspect, a non-transitory recording medium stores a plurality of instructions which, when executed by an information processing apparatus, causes the information processing apparatus to function as identification means and storage means. The identification means identifies non-text information in read data including an image. With reference to a database storing identification information of non-text information, the storage means stores the identified non-text information and identification information corresponding to the identified non-text information in association with each other.

According to a thirtieth aspect, a non-transitory recording medium stores a plurality of instructions which, when executed by one or more processors, causes the one or more processors to perform a method including reading data including an image, identifying non-text information in the read data, and with reference to a database storing identification information of non-text information, storing in a memory the non-text information identified in the identifying and identification information corresponding to the identified non-text information in association with each other.

1. An information processing system comprising:
a memory that stores a database storing identification information of non-text information; and
circuitry configured to
identify non-text information in read data including an image, and
with reference to the database, store in the memory the identified non-text information and identification information corresponding to the identified non-text information in association with each other.

2. The information processing system of claim 1, wherein the circuitry
identifies text information in the read data, and
stores the identified text information in association with the identified non-text information.

3. The information processing system of claim 1, wherein the circuitry displays a list on a display based on information read from the image and stored in the memory.

4. The information processing system of claim 3, wherein the circuitry displays the list based on filtering the non-text information.

5. The information processing system of claim 4, wherein the database includes an item for setting whether to filter the non-text information.

6. The information processing system of claim 4, wherein the circuitry displays, in the list, a thumbnail image including the filtered non-text information.

7. The information processing system of claim 1, wherein the circuitry extracts one or more pages included in the read data, and
identifies the non-text information for each of the one or more extracted pages.

8. The information processing system of claim 1, wherein the circuitry identifies a position of the non-text information, and
stores information of the identified position in association with the non-text information.

9. The information processing system of claim 1, wherein the circuitry
identifies information indicated by a two-dimensional code as the non-text information included in the read data, and
stores the information indicated by the two-dimensional code.

10. The information processing system of claim 1, wherein the database stores an image of the non-text information in association with the identification information, and
wherein the circuitry determines whether the image of the non-text information is identical to the identified non-text information.

11. The information processing system of claim 10, wherein the circuitry uses a pattern matching process to determine whether the image of the non-text information is identical to the identified non-text information.

12. The information processing system of claim 2, wherein the circuitry
makes a determination of whether the identified non-text information is identical to the non-text information stored in the database, and
stores the determination in association with the non-text information.

13. The information processing system of claim 12, wherein the circuitry makes the determination based on, in addition to the non-text information, at least one of the text information, another non-text information different from the non-text information, and additional information other than the non-text information and the text information.

14. The information processing system of claim 13, wherein the circuitry determines whether the text information and the additional information correspond to each other based on at least the non-text information and the additional information other than the non-text information and the text information, the additional information being related to read image data.

15. The information processing system of claim 13, wherein the additional information includes contact information, and
wherein the circuitry
filters the contact information based on the determination, and
contacts a party included in the contact information and selected through the filtering.

16. The information processing system of claim 3, wherein the circuitry
identifies a size of a read object in the read data, and
displays the list based on filtering with a combination of the identified size and the non-text information.

17. The information processing system of claim 16, wherein the circuitry
compares the identified size and the non-text information to make a determination of whether the identified non-text information is identical to the non-text information stored in the database, and
automatically sets a name for the combination of the identified size and the non-text information.

18. The information processing system of claim 16, wherein the circuitry identifies a position of the non-text information in the image, and
wherein the non-text information includes information related to a position of the non-text information in the read object.

19. The information processing system of claim 16, wherein the circuitry identifies a position of the non-text information, the non-text information including
first non-text information including information related to a position of the first non-text information in the read object, and
second non-text information lacking information related to a position of the second non-text information in the read object.

20. An image processing apparatus comprising circuitry configured to
identify non-text information in read data including an image, and
with reference to a database storing identification information of non-text information, store in a memory the identified non-text information and identification information corresponding to the identified non-text information in association with each other.
